(19) United States
(12) Patent Application Publication
(10) Pub. No.: US 2006/0234771 A1
(43) Pub. Date: Oct. 19, 2006

(54) Headset adapter for IP or digital phone

(75) Inventor: Michael Shavrov, Branford, CT (US)

Correspondence Address: Michael Shavrov, 42 Todds Hill Road, Branford, CT, 06405, US

(73) Assignee: Michael Shavrov, Branford, CT (US)

(21) Appl. No.: 10/907,754

(22) Filed: Apr. 14, 2005

(51) Int. Cl. H04B 1/38; H04M 1/00

(52) U.S. Cl. 455/557; 455/575.2

(57) ABSTRACT

The headset adapter allows using standard cell phone headset with IP or digital phone, equipped with built-in modular headset jack. Adapter comprises of three basic components: RJ-9 modular plug, 4-conductor cable, and 2.5 mm stereo phone jack. Components connected to couple phone signals with standard headset circuits.

### FIELD OF INVENTION

The present invention relates to field of terminal devices and more particularly to the field of telephone headsets connected physically and electrically to IP of digital phones.

### BACKGROUND OF INVENTION

Headsets commonly used with communication systems to provide users with a comfortable, more productive, and healthier way to use a phone. In the modern world, people may perform multiple tasks while on the phone—for example, book an order, enter data, or take notes. While using standard handset in these situations, people very often “scrunch” the receiver between our ear and shoulder, so that they can use both hands to complete a task. This causes Telephone Neck Syndrome malady. According to independent researches, using headsets instead of regular handset can increase overall productivity for up to 43% while reduce neck, shoulder and upper back muscle tension as much as 41% by using headsets.

Modern IP and digital phones, such as Cisco 79xx series, Avaya 46xx series, Lucent/AT&T IP phones, as well as other models of digital phones, are equipped with built-in headset jack. This feature allows users to connect the headset directly to the phone without using specialized switch or amplifier, and use phone's embedded functionality, like switching between handset, headset, or speakerphone; store volume settings for headset, handset, and speakerphone, etc.

There are two solutions available on the market: (1) switch/amplifier, connected to handset jack of the phone, which interfaces the standard handset and proprietary headset with the phone, (2) headset with modular RJ-9 plug, connected directly to the phone, or through proprietary adapter. Both of these solutions are vendor specific, proprietary, and not compatible with other vendors' products.

There are two solutions available on the market: (1) switch/amplifier, connected to handset jack of the phone, which interfaces the standard handset and proprietary headset with the phone, (2) headset with modular RJ-9 plug, connected directly to the phone, or through proprietary adapter. Both of these solutions are vendor specific, proprietary, and not compatible with other vendors' products.

Leading companies like Plantronics, GN, and VXI, offer number of models of headphones, but their solutions are unreasonably expensive, and very un-flexible. Most of headsets, manufactured by those companies, equipped with proprietary “quick disconnect” plugs, what makes them incompatible with another headsets and components.

At the same time, market saturated with variety of standard headsets for cell phones. Most of cell phone headsets are equipped with standard 2.5 mm phone connector, and have standard signaling. Selection of cell phone headsets styles can satisfy any user. Moreover, because of high competition on the market, same manufactures, as Plantronics, GN, and VXI, sell standard cell phones headsets, with similar or even better functionality, for fraction of cost of “proprietary headsets”. In addition to mentioned benefits of using standard cell phone headset, users can even have same headset for both, cell phone, and desk phone.

### SUMMARY OF INVENTION

The most logical approach to overcome described problem would be to interface a phone with built-in headset jack, with standard cell phone headset. The phone provides electrical signals to work with headset. Therefore, if we would provide appropriate signals to standard headset connector, we will be able to use any standard headset with a phone.

Most of the modern IP and digital phones use same type of modular RJ-9 jack for both, handset and headset. Headset jack though has different signaling, than handset jack: Speaker (+), Microphone (−), Microphone (+), Speaker (−) (FIG. 2).

Standard cell phone headset with 2.5 mm plug uses following signaling: Sleeve—Common Ground; Ring—Microphone; Tip—Speaker (FIG. 3).

Connecting speaker output signal with the speaker circuit on the headset, and headset microphone signal with the phone microphone circuit, we can interface standard cell phone headset with mentioned IP or digital phones.

### BRIEF DESCRIPTION OF THE DRAWINGS

FIG. 1 Electrical diagram of components.

FIG. 2 IP or digital phone headset jack signaling.

FIG. 3 Standard cell phone headset signaling.

FIG. 4 Adapter design with 2.5 mm in-line stereo jack, curly cord, and RJ-9 plug.

FIG. 5 Adapter design with 2.5 mm in-line stereo jack, straight cord, and RJ-9 plug.

FIG. 6 Adapter design with 2.5 mm panel-mountable stereo jack in the housing; curly cord; and RJ-9 plug.

FIG. 7 Adapter design with 2.5 mm panel-mountable stereo jack in the housing; straight cord; and RJ-9 plug.

What is claimed is:

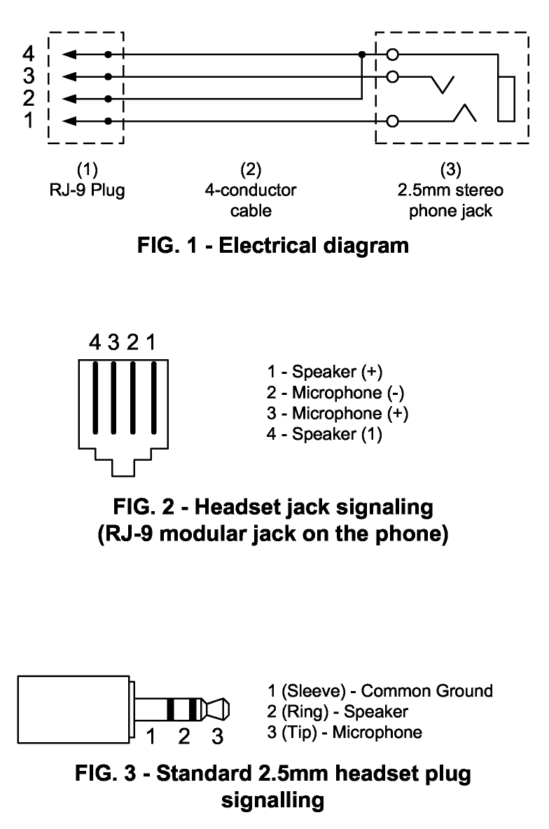

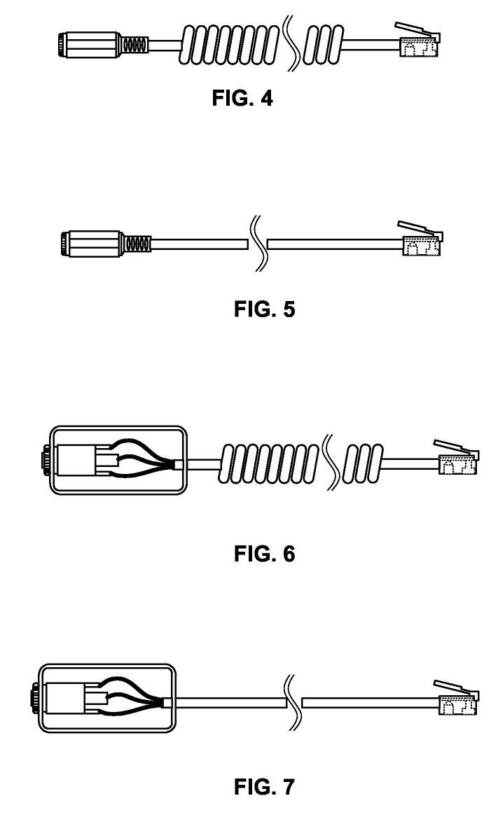

1. Headset adapter interfaces standard cell phone headset with 2.5 mm plug, and IP or digital phone, equipped with built-in modular headset jack. Adapter comprises of RJ-9 plug (1), and 2.5 mm in-line stereo phone jack (3), coupled by 4-conductor cable (3) according to scheme on FIG. 1.

2. Headset adapter of claim 1, wherein 2.5 mm panel mount stereo phone jack placed in any type of housing.

3. Headset adapter of claim 1, wherein 4-conductor curly cable used.

4. Headset adapter of claim 2, further comprising any additional electronic, electrical or mechanical components, placed within housing, i.e. mute switch, volume control, amplifier, etc. as long as adapter performs same function as described in claim 1.
